(19) United States
(12) Patent Application Publication
(10) Pub. No.: US 2026/0115641 A1
(43) Pub. Date: Apr. 30, 2026

(54) SYSTEM AND METHOD FOR GAS TREATMENT

(71) Applicant: CoolVOC Ltd., Herzliya (IL)

(72) Inventors: Yariv Gober, Herzliya (IL); Avihai Israel, Herzliya (IL)

(21) Appl. No.: 19/483,992

(22) PCT Filed: May 15, 2024
(86) PCT No.: PCT/IL2024/050468

§ 371 Date: Nov. 13, 2025

(30) Foreign Application Priority Data
May 15, 2023 (IL) 302930

(51) Int. Cl. B01D 53/04; B01D 53/00

(52) U.S. Cl. CPC B01D 53/0454; B01D 53/002; B01D 53/0438; B01D 53/0446; B01D 2253/10; B01D 2253/20; B01D 2257/708; B01D 2259/40003; B01D 2259/4009

(57) ABSTRACT

A gas treatment system and method are disclosed. The system may include comprising: one or more volatile compound (VC) adsorbing units, each comprising: a VC adsorbing bed comprising a porous VC adsorbing material; and two or more valve units each connected at one end of the VC adsorbing bed; at least one compressor configured to receive inert gas with adsorbed VC; a heat exchanger configured to exchange heat between the compressed inert gas with adsorbed VC and a VC-free inert gas, wherein at least one of the valve units is configured to receive hot VC-free inert gas heated by the heat exchanger; and a chiller configured to chill the compressed VC adsorbed inert gas to allow condensation of the VC from the VC adsorbed inert gas stream.

### CROSS-REFERENCE TO RELATED APPLICATIONS

The Application claims the benefit of priority of Israel Patent Application No. 302930, titled “A METHOD AND SYSTEM FOR VOC POLLUTION CONTROL USING ZEOLITE AND CONDENSATION”, filed 15 May 2023, the contents of which are incorporated herein by reference in their entirety.

### FIELD OF THE INVENTION

The present invention relates generally to gas treatment systems and methods. More specifically, the present invention relates to gas treatment systems and methods for removing volatile compounds from a stream of gas.

### BACKGROUND OF THE INVENTION

Volatile organic compounds (VOCs) are organic chemicals that have a high vapor pressure at room temperature. These compounds are often emitted by various industrial processes. VOCs are also present in many consumer products such as cleaning agents, solvents, and paints, among others. When released into the atmosphere, VOCs contribute to air pollution and can have negative impacts on human health and the environment.

There are several methods available for controlling VOCs emission from various sources. One such method is the use of bed adsorption systems, where the contaminated air is passed through a fixed or rotating bed of adsorbent material such as activated carbon, zeolites, or molecular sieves, some of whom are commercially known as Rotary Concentrator Thermal Oxidizer (RCTO). The adsorbent material captures the VOCs and clean air is discharged to the environment. However, the adsorption process is limited, and the adsorbent material needs to be regenerated to maintain its effectiveness. This is typically done by heating the adsorbent bed to desorb the VOCs, which requires significant amounts of energy and can be expensive.

Another method for controlling VOCs emissions is the use of condensation systems. In this approach, the contaminated air is cooled to the dew point, of the VOC, and can be separated from the air on the basis of phase separation. The clean air is then discharged from the system. However, this method is not effective for VOCs that have low boiling points and are usually require very low temperatures that in large scale consume also large energy usage.

A more effective approach is to combine bed adsorption with condensation. This method involves passing the contaminated air through an adsorbent material, such as zeolite, thus creating high concentration of the VOC on the adsorbing bed and later desorbing it with relatively small amount of hot air and hence create a concentrator. The concentrated air stream from the desorbed zeolite is being cooled to the dew temperature where the VOCs condenses. The condensed VOCs are then removed from the system. This approach has been shown to be effective for a wide range of VOCs.

However, all of these methods are large energy consumers and require moving parts equipment therefore, making them, energy inefficient and complicated.

There is a need for simpler and more efficient system and method that uses static beds thus enabling the beds to be customized for a specific need.

### SUMMARY OF THE INVENTION

Some aspects of the invention may be directed to a gas treatment system. The system may include comprising: one or more volatile compound (VC) adsorbing units, each comprising: a VC adsorbing bed comprising a porous VC adsorbing material; and two or more valve units each connected at one end of the VC adsorbing bed; at least one compressor configured to receive inert gas with adsorbed VC; a heat exchanger configured to exchange heat between the compressed inert gas with adsorbed VC and a VC-free inert gas, wherein at least one of the valve units is configured to receive hot VC-free inert gas heated by the heat exchanger; and a chiller configured to chill the compressed VC adsorbed inert gas to allow condensation of the VC from the VC adsorbed inert gas stream.

In some embodiments, the two or more valve units may include a first valve unit, interchangeably connecting the VC adsorbing bed to one of: laden exhaust gas inlet, and a VC adsorbed inert gas outlet, located at one end of the VC adsorbing bed; and a second valve unit, interchangeably connecting the VC adsorbing bed to one of: a clean exhaust outlet, and to a VC-free inert gas inlet, located at another end of the VC adsorbing bed.

In some embodiments, the system may further include a controller configured to control at least one of, any one of the valves, and the compressor.

In some embodiments, the controller may be configured to: set a cleaning cycle by controlling at least one valve to provide laden exhaust gas to the VC adsorbing bed via the exhaust gas inlet and to control at least one other valve to extract cleaned exhaust gas via a cleaned exhaust gas outlet.

In some embodiments, the controller may further be configured to: set a regeneration cycle by: terminating the provision of laden exhaust gas to the VC adsorbing bed via the first valve; controlling the provision of hot VC-free inert gas into the VC adsorbing bed via the second valve; controlling the compressor to compress the VC adsorbed inert gas received from the first valve; and controlling the chiller unit to recover VC from the VC adsorbed inert gas.

In some embodiments, controlling the provision of hot VC-free inert gas may include generating VC-free inert gas flow from an inert gas source based on a pressure difference between the inert gas source and the VC adsorbing bed.

In some embodiments, the system may further include a first VC adsorbing unit and at least one more second VC adsorbing unit, and wherein the controller is configured to set the regeneration cycle for the first VC adsorbing unit, and to set the cleaning cycle for at least one more second VC adsorbing unit. In some embodiments, the regeneration cycle may further include: following the provision of hot VC-free inert gas into the VC adsorbing bed of the first VC adsorbing unit, controlling, the first valve, of the first VC adsorbing unit, to provide the VC adsorbed inert gas from the adsorbed bed, into the laden exhaust gas inlet of the second VC adsorbing unit. In some embodiments, providing the VC adsorbed inert gas from the first VC adsorbing unit may be to an upstream of the adsorbed bed of the second VC adsorbing unit.

In some embodiments, the system may further include: a heater located before the VC-free inert gas inlet, and wherein the controller is configured to control the heater to heat the VC-free inert gas to a temperature of at least 150° C., if the temperature of the VC-free inert gas is below 150° C.

In some embodiments, the heat exchanger may be fluidically connected between the compressor and the chiller via VC adsorbed inert gas pipeline; and fluidically connected between an inert gas source, and at least one of the valve units, via VC-free inert gas pipeline. In some embodiments, the compressor may be configured to compress the VC adsorbed inert gas to between 2 to 10 bar. In some embodiments, the temperature of the VC adsorbed inert gas at an exit from the compressor is at least 160° C.

In some embodiments, the temperature of the VC-free inert gas at an exit from the heat exchanger may be at least 140° C. In some embodiments, the temperature of the VC adsorbed inert gas at an exit from the heat exchanger may be at most 40° C. In some embodiments, the Reynolds no. of the VC-free inert gas provided to the VC adsorbing unit may be above 3000. In some embodiments, the inert gas may be selected from nitrogen, helium, argon, carbon dioxide, and any combination thereof.

In some embodiments, the porous VC adsorbing material may include at least one of: zeolite, activated carbon, metal-organic frameworks, special clay material, activated alumina, and hyper-crosslinked polymeric resin. In some embodiments, the system may further include at least one sensor configured to measure a value indicative of the ability of the porous VC adsorbing material to further adsorb VC. In some embodiments, the sensor may be at least one of, a flowmeter, a delta pressure sensor, a scale, and exhaust motor load device.

Some additional aspects of the invention may be directed to a method of treating gas comprising:
(a) setting a cleaning cycle in at least one volatile compound (VC) adsorbing unit of a gas cleaning system by controlling a first valve unit to provide laden exhaust gas to a VC adsorbing bed via a laden exhaust gas inlet and to control a second valve unit to extract clean exhaust gas, from the VC adsorbing bed via a clean exhaust gas outlet; and
(b) monitoring VC adsorbing bed by measuring the value indicative of the ability of the porous VC adsorbing material to adsorb VC;
(c) detecting a threshold value for the value indicative of the ability of the porous VC adsorbing material to adsorb VC; and
(d) setting a regeneration cycle by:
   terminating the provision of laden exhaust gas to the VC adsorbing bed via the first valve unit;
   controlling the provision of hot VC-free inert gas into the VC adsorbing bed via the second valve unit;
   controlling a compressor to compress the VC adsorbed inert gas received from the first valve unit;
   circulating the compressed the VC adsorbed inert gas and a VC-free inert gas in a heat exchanger; and
   controlling a chiller to recover VC from the VC adsorbed inert gas.

In some embodiments, the method may further include controlling the provision of hot VC-free inert gas into the VC adsorbing bed further comprises heating VC-free inert gas using an additional heater. In some embodiments, the temperature of the hot VC-free inert gas at the entrance to the second valve may be at least 150° C. and has a pressure lower than 1.5 bar.

In some embodiments, the method may further include setting the regeneration cycle in a first VC adsorbing unit; and setting the cleaning cycle in at least one second VC adsorbing unit. In some embodiments, the method may further include controlling the first valve of the first VC adsorbing unit, to provide a mixture of the laden exhaust gas and the VC adsorbed inert gas from the adsorbed bed, into the exhaust gas inlet of at least one second or VC adsorbing unit.

In some embodiments, the method may further include:
receiving a value indicative of the concentration of VC in the VC-free inert gas, and
if the concentration is above a VC safety threshold concentration:
(a) send an alert to an external computing device; or
(b) stop the regeneration cycle.

In some embodiments, the value indicative of the concentration of VC may be received from at least one of: an oxygen sensor, and a Lower Explosive Limit (LEL) sensor.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A and 1B are block diagrams of gas treatment systems according to some embodiments of the invention;

FIG. 1C is a block diagram of the control system of the gas treatment system according to some embodiments of the invention;

FIGS. 2A and 2B are images of two views of a three-dimensional (3D) model of industrial gas treatment system according to some embodiments of the invention;

FIG. 3A is a flowchart of a method of for treating gas according to some embodiments of the invention;

FIG. 3B is a flowchart of a regeneration cycle according to some embodiments of the invention; and

FIG. 4 is a block diagram, depicting a computing device which may be included in a system for gas treatment system according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Some aspects of the invention may be directed to gas treatment systems for laden exhaust gas, for example, polluted air. The laden exhaust gas may include an undesired amount of Volatile Compounds (VCs), organic or inorganic that may need to be removed from the gases. The removing of the VCs may allow releasing the gas (e.g., air, oxygen, nitrogen, etc.) into the atmosphere, or collect the gas for reuse.

A method and system according to embodiments of the invention may include compressing a concentrated stream containing the VCs in order to let the VCs to condensate (liquified) in a much higher temperature. A high concentration of VCs may reach level that may impose risk of explosion of the concentrated air stream, therefore, the air may be replaced with inert gas. Additionally, the system may use the heat created by the compression of the gas, and usually treated as an unwanted by product for any compression process, as a heat used for the desorption of the adsorption beds.

As used herein “Volatile Compound” may refer to any chemical compound (either organic (VOC) or inorganic) that have a high vapor pressure at room temperature. Some nonlimiting examples for VC may include, ammonia, methanol, isoprene, terpenes, pinene isomers, sesquiterpenes, and the like.

A system according to embodiments of the invention may include: one or more VC adsorbing beds comprising a porous VC adsorbing material, at least one compressor configured to receive inert gas with adsorbed VC; a heat exchanger configured to exchange heat between the compressed inert gas with adsorbed VC and a VC-free inert gas wherein one of the at least two valves may be configured to receive hot VC-free inert gas heated by the heat exchanger; and a chiller configured to chill the VC adsorbed inert gas to allow condensation of the VC from the VC adsorbed inert gas stream. The system may further include a controller, one or more sensors and a plurality of valves allowing to control the flow of both the laden exhaust gas to be clean and inert gas use for regeneration of the porous VC adsorbing material.

Some additional objects of the invention may include providing an abatement system that uses both pressurizing the inert gas (with the VCs) and cooling it to enhance condensation of the VCs, optionally, below zero (° C.).

The gas treatment system according to embodiments of the invention may allow to reduce energy waste while desorbing the VCs from the adsorbing materiel, by using the excess energy generated by compressing the inert gas as the main heat source for the desorption.

Additional aspects of the invention may be directed to the ability to operate the system on-demand (as opposed to continuous operation). Thereby, allowing relatively long intervals between desorption cycles, contrary to the currently used rotating adsorption wheel methods and systems.

In some embodiments, an object of the invention may include avoiding explosion levels of VCs at the regeneration cycle by using close-loop inert gas as the carrying gas for the regeneration cycle.

In some embodiments, another object of the invention may include avoiding water condensation in extra low temperature preventing ice formation by using close-loop dry inert gas as the carrying gas for the regeneration cycle. Inert gas such as nitrogen with extra low water vapor content may prevent both water condensation and ice formation while the recovery of the VCs occurs, at low temperature and high pressure.

In some embodiments, another object of the invention may include reusing or reclaiming the condensed VCs by using a closed-loop and inert gas as a desorption gas in the regeneration cycle, thereby preventing secondary contamination.

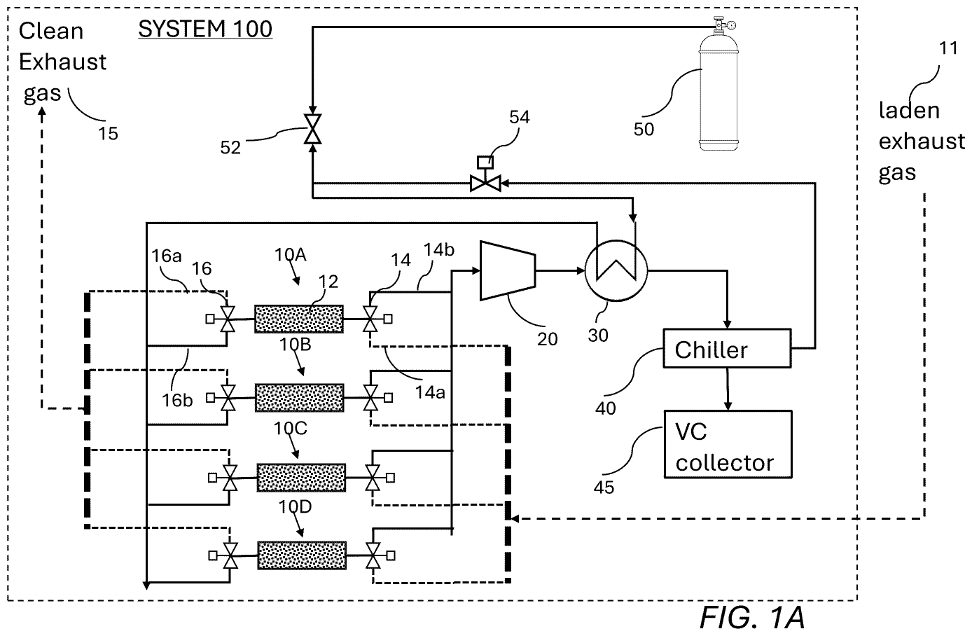

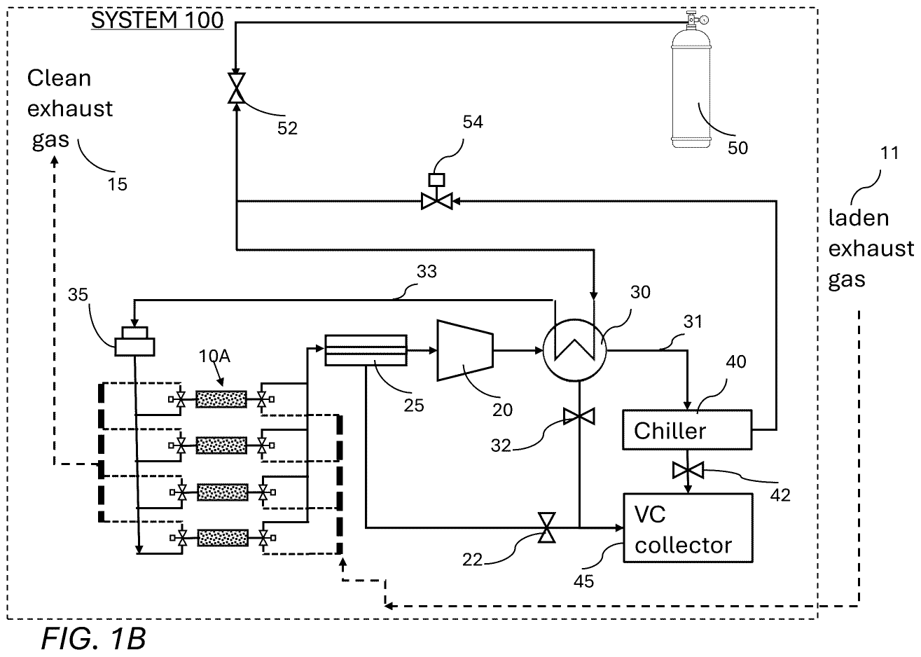

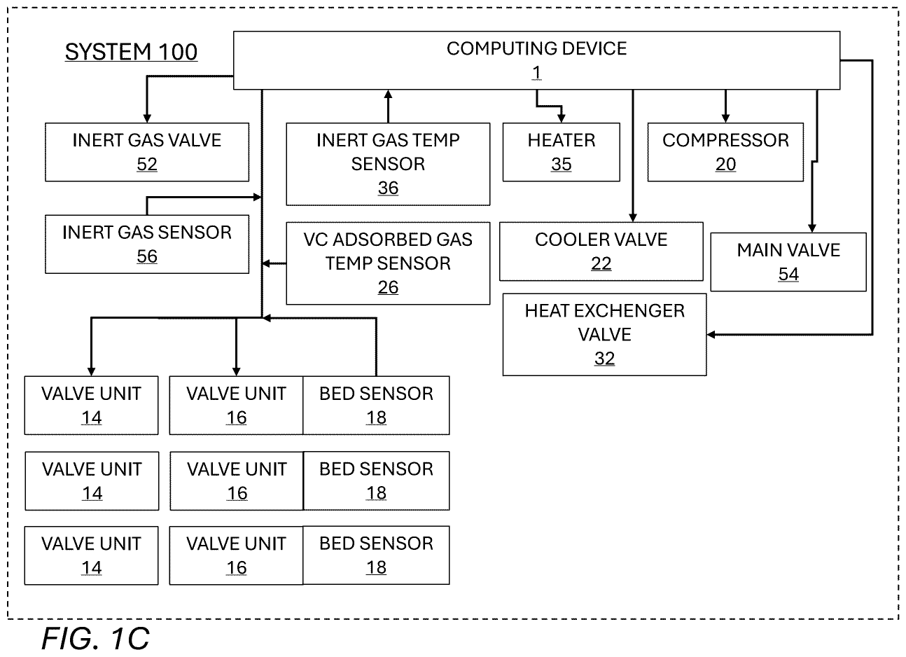

Reference is now made to FIGS. 1A and 1B which are block diagrams of gas treatment systems according to some embodiments of the invention, and further to FIG. 1C which is a block diagram of the control system of the gas treatment system according to some embodiments of the invention.

A gas treatment system 100, according to some embodiments of the invention may include one or more VC adsorbing units 10A, 10B, 10C, 10D, etc. VC adsorbing units 10A, 10B, 10C, 10D may be configured to receive laden exhaust gas, clean the laden exhaust gas by adsorbing the VCs from the laden exhaust gas and produce clean exhaust gas. Units 10A, 10B, 10C, 10D may further be configured to be regenerated, as discussed hereinbelow.

Each one of VC adsorbing units 10A, 10B, 10C, 10D may include a VC adsorbing bed 12 comprising a porous VC adsorbing material, and two or more valve units 14 and 16 each connected at one end of VC adsorbing bed 12. In some embodiments, porous VC absorbing material may be a material having large surface area that is capable of absorbing VCs. In some embodiments, the porous VC absorbing material may be selected to adsorb a specific VC or a group of different VCs. Some nonlimiting examples for porous VC absorbing materials may include zeolite, activated carbon, metal-organic frameworks, special clay material, activated alumina, hyper-crosslinked polymeric resin, and the like.

In some embodiments, two or more valve units 14 and 16 may include a first valve unit 14, interchangeably connecting VC adsorbing bed 12 to one of: laden exhaust gas inlet 14a, and a VC adsorbed inert gas outlet 14b, located at one end of VC adsorbing bed 12. In some embodiments, two or more valve units 14 and 16 may include a second valve unit 16, interchangeably connecting VC adsorbing bed 12 to one of: a clean exhaust outlet 16a, and to a VC-free inert gas inlet 16b, located at another end of VC adsorbing bed 12. Valve units 14 and 16 may each include a 3-way valve, 3 single-way valves, a single way valve and bidirectional valve and the like.

As should be understood by one skilled in the art, the 4 VC adsorbing units 10A, 10B, 10C, 10D illustrated in FIGS. 1A and 1B are given as an example only, and the invention is not limited to any specific number of VC adsorbing units. For example, gas treatment 100 may include 1, 2, 3, 4, 5, 6, or more VC adsorbing units.

In some embodiments, during an exhaust gas cleaning cycle (marked with a dashed line) laden exhaust gas may be provided from exhaust gas source 11 to one or more of VC adsorbing units 10A, 10B, 10C, 10D, via laden exhaust gas inlets 14a. The VCs in the laden exhaust gas may be adsorb by porous VC absorbing material to produce clean exhaust gas 15. As used herein a clean exhaust gas may be a gas that continues less than 20 PPM VCs. In some embodiments, clean exhaust gas 15 may be released/exit via clean exhaust gas valve 16a.

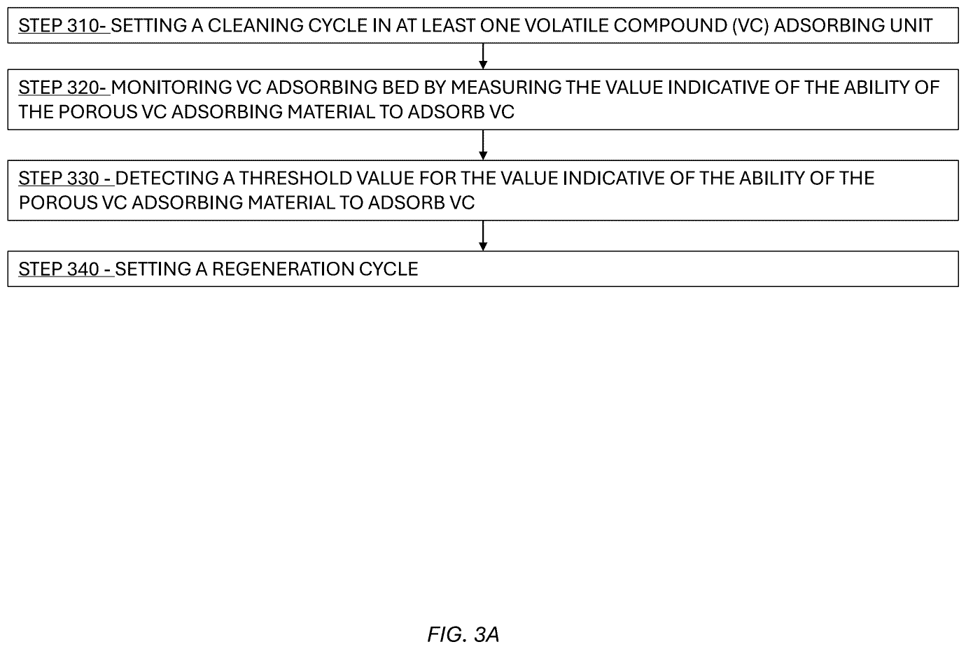

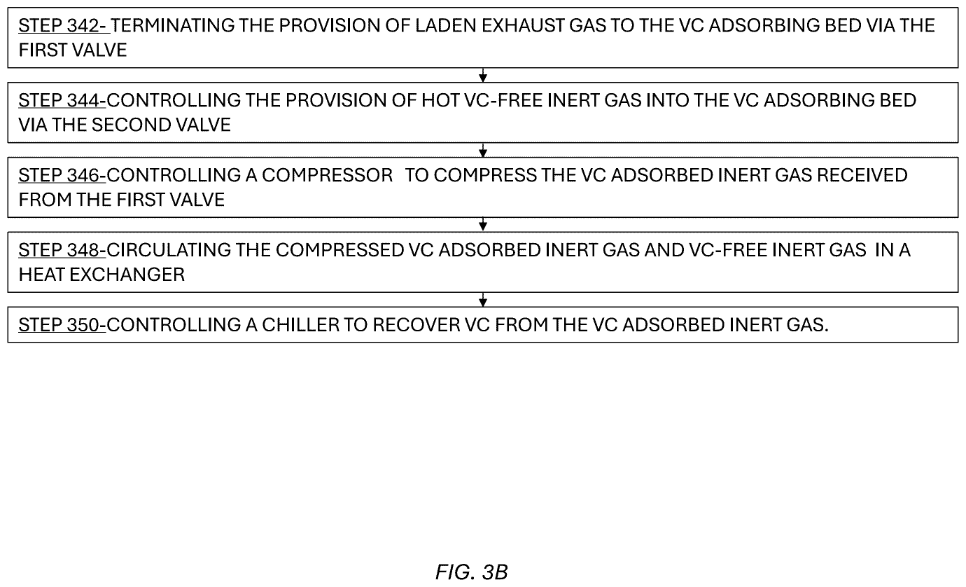

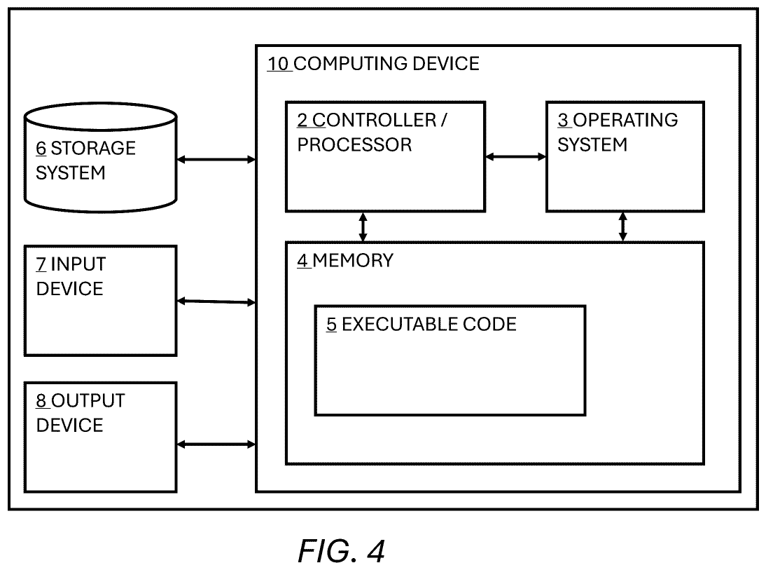

In some embodiments, once the amount of VCs adsorbed in VC absorbing material increased to an amount that at least partially blocks the VC absorbing material, a regeneration cycle (illustrated in solid line) may be initiated. In some embodiments, the initiation of the cleaning cycle and the regeneration cycle may be conducted under the control of computing device 1, illustrated in FIGS. 1C and 4, according to the method illustrated and discussed with respect to FIG. 3 herein below.

In some embodiments, system 100 may include one or more adsorption bed sensors 18 configured to measure a value indicative of the ability of the porous VC adsorbing material to further adsorb VC. In some embodiments, adsorption bed sensor 18 may be at least one of, a flowmeter, a delta pressure sensor, a scale, and exhaust motor load device. Adsorption bed sensor 18 may measure at least one of the amount of VCs adsorbed in adsorbing bed 12, the gas flow, or the gas pressure in the presence of VCs in adsorbing bed 12, and the like.

In some embodiments, for the regeneration cycle, gas treatment system 100 may further include inert gas source 50 that may provide inert gas to the regeneration process. Inert gas source 50 may be pipelines, pressurized gas tanks and the like. Some nonlimiting examples for inert gases may include nitrogen, helium, argon, carbon dioxide, and any combination thereof. In some embodiments, the provision of VC-free (e.g., clean) inert gas may be controlled by main a valve 54. The VC-free inert gas may be provided at a pressure of at least 1 bar.

As used herein a VC-free inert gas may be an inert gas that continues less than 100 PPMvol. VCs.

In some embodiments, the VC-free inert gas may be provided to one or more of VC adsorbing units 10A, 10B, 10C, 10D, via VC-free inert gas inlet 16b, at a temperature of at least 150° C. Therefore, there is a need to heat VC-free inert gas prior to the provision of the gas to VC adsorbing units 10A, 10B, 10C, 10D.

In some embodiments, the Reynolds number of the VC-free inert gas provided to VC adsorbing units 10A, 10B, 10C or 10D is above 3000, for example, above 5000, above 7500, above 10,000, above 15,000, above 20,000, above 25,000, above 30,000, above 40,000 or more. Therefore, the flow inside adsorbing bed 12 is highly turbulent.

The regeneration cycle comprises at least one compressor 20 configured to receive inert gas with adsorbed VC; and a heat exchanger 30 configured to exchange heat between the compressed inert gas with adsorbed VC and a VC-free inert gas received from inert gas source 50. In some embodiments, valve 16 may be configured to receive hot VC-free inert gas heated at least by the heat exchanger 30. In some embodiments, system 100 may further include a heater 35 (illustrated in FIG. 1B) located before (e.g., upstream from) VC-free inert gas inlet 16b, if additional heat may be required. In some embodiments, controller 1 may be configured to control heater 35 to heat the VC-free inert gas to a temperature of at least 150° C., if the temperature of the VC-free inert gas is below 150° C. In some embodiments, controller 1 may receive measurements of the temperature of VC-free inert gas from inert gas temperature sensor 36 (illustrated in FIG. 1C) located at the entrance of heater 35.

In some embodiments, heat exchanger 30 may circulate the same type of inert gas with or without VCs. For example, heat exchanger 30 may be a nitrogen/nitrogen+VCs heat exchanger, CO₂/CO₂+VCs heat exchanger, argon/argon+VCs heat exchanger, and the like.

In some embodiments, compressor 20 may be any compressor that can compress inert gas with adsorbed VC. The compressor may be any compressor known in the art, for example, pressure-controlled compressor, a positive displacement compressor, a reciprocating compressor, a liner compressor, or any other compressor with ability to change it's capacity by changing the compressor's speed. In some embodiments, compressor 20 may be configured to compress the VC adsorbed inert gas to between 2 to 10 bar, for example, between 2 to 4 bar, between 3 to 5 bar, between 4 to 7 bar, between 6 to 8 bar, and between 8 to 10 bar and any value and range in between. During the compression about 80% of the energy may be transferred into heat, therefore, the temperature of the VC adsorbed inert gas at an exit from compressor 20 is higher than the VC adsorbed inert gas in the entrance to compressor 20 and may reach at least 160° C.

In some embodiments, when circulated via heat exchanger 30, the hot VC adsorbed inert gas may be cooled down and heat the VC-free inert gas. Therefore, the temperature of the VC adsorbed inert gas at an exit of heat exchanger 30 is lower than when entering heat exchanger 30 and may reach a temperature of 40° C. and even lower, and the temperature of the VC-free inert gas at an exit from the heat exchanger is higher than when entering heat exchanger 30 and may reach a temperature of at least 140° C.

During the cooling of the hot VC adsorbed inert gas inside heat exchanger 30, at least some of VCs (e.g., 90 vol. %) may condense into liquid VCs, that may be collected by a VC collector 45, under the control of heat exchanger valve 32 (illustrated in FIGS. 1B and 1C).

In some embodiments, gas treatment system 100 may further include a chiller 40 that may be configured to chill the VC adsorbed inert gas to allow condensation of the VC from the VC adsorbed inert gas stream. Chiller 40 may be a heat exchanger with a cooling liquid stream, a cooler, a refrigerator and any other chilling unit. The VC condensed in chiller 40 may be collected by VC collector 45, and the inert gas, now free from VCs may return into the VC-free inert gas pipeline, for example, via main valve 54. Main valve 54 may ensure that the pressure of VC-free inert gas prior to entering heat exchanger 30 and/or heater 35 is below 1 bar.

In some embodiments, heat exchanger 30 may be fluidically connected between compressor 20 and chiller 40 via VC adsorbed inert gas pipeline 31; and fluidically connected between inert gas source 50, and valve unit 14, via VC-free inert gas pipeline 33.

In some embodiments, gas treatments system 100 may further include a cooler 25 configured to cool down the hot VC adsorbed inert gas exiting adsorbing bed 12 prior to entering compressor 20. Since the temperature of VC adsorbed inert gas is expected to further rise due to compression it may be beneficial to cool the VC adsorbed inert gas first to below 35° C. using cooler 25. Cooler 25 may be a heat exchanger with a cooling liquid stream, a chiller, a refrigerator and any other cooling unit. In some embodiments, at least some of the VCs (e.g., about 80 vol. %) may already be condensed in cooler 25 and may be collected by VC collector 45 by controlling cooler valve 22 to allow the accumulation of liquid VCs from cooler 25 to VC collector 45.

In some embodiments, gas treatment system 100 may further include an inert gas sensor 56 configured to measure a value indicative of the concentration of VC in the VC-free inert gas. For example, sensor 56 may be an oxygen sensor configured to measure oxygen level in the VC-free inert gas, a Lower Explosive Limit (LEL) sensor configured to measure the combustion of combustible VCs in the VC-free inert gas, and the like.

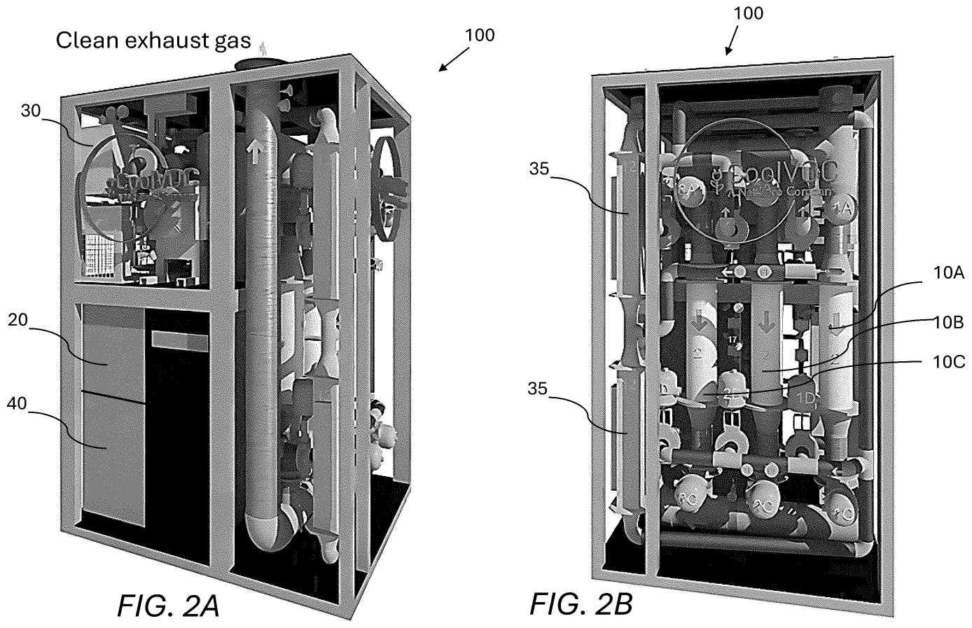

Reference is now made to FIGS. 2A and 2B which are images of two views of a 3D model of industrial gas treatment system according to some embodiments of the invention. In the nonlimiting example of FIGS. 2A and 2B, gas treatment system 100 may include three VC adsorbing units 10A, 10B and 10C, a compressor 20, a heat exchanger 30 and a chiller 40. System 100 may further include two heaters 35. System 100 may further include an inert gas source and a VC collector (not shown) and any one of the valves, components and units discussed herein above with respect to FIGS. 1A, 1B and 1C.

Reference is now made to FIG. 3A which is a flowchart of a method of treating gas according to some embodiments of the invention. The method of FIG. 3A and further of FIG. 3B may be conducted by a controller, such as computing device 1, using a code stored in a memory 4 (illustrated and discussed with respect to FIG. 4), or using any other controller. The method may control system 100 to clean laden exhaust gas and regenerate VC adsorbing units, such as units 10A-10D in FIGS. 1A and 1B, when necessary.

In step 310, the method may include setting a cleaning cycle in at least one volatile compound (VC) adsorbing unit 10A-10D of a gas cleaning system 100 by controlling a first valve 14 to provide laden exhaust gas to a VC adsorbing bed 12 via a laden exhaust gas inlet 14a and to control a second valve 16 to extract clean exhaust gas 15, from VC adsorbing bed 12 via clean exhaust gas outlet 16a. In some embodiments, the laden exhaust gas may be polluted air but can also be any other gas containing fume of VC that needs to be adsorb prior releasing the gas to the surroundings (i.e. Oxygen, Nitrogen, Helium and the like)

In step 320, the method may include monitoring VC adsorbing bed 12 by measuring the value indicative of the ability of the porous VC adsorbing material to further adsorb VC. For example, adsorbing bed sensor 18 may measure at least one of: the pressure drop across VC adsorbing bed 12, the weight of VC adsorbing unit 10A-10D, the exhaust motor load and the like.

In step 330, the method may include detecting a threshold value indicative of the ability of the porous VC adsorbing material to further adsorb VC.

In some embodiments, when the threshold value is detected, the method may include, in step 340, setting a regeneration cycle.

FIG. 3B is a flowchart of a regeneration cycle according to some embodiments of the invention.

In step 342, the regeneration cycle may include terminating the provision of laden exhaust gas to the VC adsorbing bed via first valve unit 14. For example, the controller may close inlet 14a.

In step 344, the regeneration cycle may include controlling the provision of hot VC-free inert gas into the VC adsorbing bed via second valve unit 16. For example, an initial amount of VC-free inert gas may be heated up using heater 35 to at least 150° C. As the regeneration cycle proceed the VC-free inert gas is heated using heat exchanger 30, and heater 35 may be operated if the temperature of VC-free inert gas drops below 150° C. The temperature of the VC-free inert gas may be measured by inert gas temperature sensor 36.

In some embodiments, main valve 54 may be controlled to create a pressure drop across the inert gas regeneration pipelines. In some embodiments, controlling the provision of VC-free inert gas may include generating VC-free inert gas flow from a high pressure side of an inert gas loop (e.g., prior to entering adsorbing units 10A-10D)) and backed up by inert gas source, based on pressure difference between the high pressure side of the loop and the low pressure of the inert gas source, at the exit from adsorbing units 10A-10D.

In step 346, the regeneration cycle may include controlling compressor 20 to compress the VC adsorbed inert gas received from first valve unit 14. For example, compressor 20 may compress the VC adsorbed inert gas to between 2 to 10 bar, therefore, the temperature of the VC adsorbed inert gas may be at least 160° C. at the exit from compressor 20.

In a nonlimiting example, compressor 20 and main valve 54 may be operated together, and the pressure in main valve 54 may increase until about 90% of compressor speed from which compressor 20 controls the pressure in the process.

In step 348, regeneration cycle may include circulating the compressed VC adsorbed inert gas and a VC-free inert gas in heat exchanger 30. In some embodiments, the controller may control a set of valves, and valve units such as valve units 14 and 16, heat exchanger valve 32, inert gas 52, main valve 54 and the like to circulate the compressed the VC adsorbed inert gas and a VC-free inert gas in heat exchanger 30.

In step 350, the regeneration cycle may include controlling chiller 40 to recover VC from the VC adsorbed inert gas. In some embodiments, chiller 40 may reduce the temperature of the VC adsorbed inert gas to a condensation temperature of the VC, thereby condensing the VC vapors into liquid. In a nonlimiting example, the condensation temperature may be below 30° C., below 10° C., below, 5° C., below, 3° C., below, 1° C., below, 0° C., below, −2° C., below, −5° C. and below −15° C.

In some embodiments, the condensed VCs may be collected by VC collector 45.

In some embodiments, the method may include setting the regeneration cycle in at least a first VC adsorbing unit 10A and setting the cleaning cycle in at least one second VC adsorbing unit 10B. For example, the controller may control first valve 14 of first VC adsorbing unit 10A, to provide a mixture of the laden exhaust gas and the VC adsorbed inert gas from adsorbed bed 12, into laden exhaust gas inlet 14a of at least one second VC adsorbing unit (e.g., unit 10B). In this process access laden exhaust gas may be pushed out from first VC adsorbing unit 10A by flushing adsorbing bed 12 with inert gas, preparing first VC adsorbing unit 10A to the generation cycle. Therefore, the mixture of the laden exhaust gas and the VC adsorbed inert gas may be provided to adsorbing bed 12 of second VC adsorbing unit 10B for further cleaning. This may allow regenerating only some of the VC adsorbing units, while allowing the rest of the units to continue and clean the laden exhaust gas.

In some embodiments, the method may further include receiving a value indicative of the concentration of VC in the VC-free inert gas, for example, from inert gas sensor 56, and if the concentration is above a VC safety threshold concentration: send an alert to an external computing device; or stop the regeneration cycle. The VC safety threshold concentration may be determined by assessing the explosion with level of the VC combination of the oxygen level and may not exceed 0.5 LEL or it may use solelyon the oxygen level in the inert gas loop to not exceed 1.5% of the gas concentration.

Reference is now made to FIG. 4, which is a block diagram depicting a computing device, which may be included within an embodiment of gas treatment system, according to some embodiments.

Computing device 1 may include a processor or controller (PLC) 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task or script. Executable code 5 may be executed by processor or controller 2 possibly under control of operating system 3. For example, executable code 5 may be an application that may control a gas treatment system as further described herein. Although, for the sake of clarity, a single item of executable code 5 is shown in FIG. 4, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data related to gas treatment system 100 may be stored in storage system 6 and may be loaded from storage system 6 into memory 4 where it may be processed by processor or controller 2. In some embodiments, some of the components shown in FIG. 4 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

### Example

In a working example, a simulation for the system shown in FIGS. 2A and 2B was made. The gas treatment system had 3 VC adsorbing units 10A, 10B and 10C. Each unit included zeolite having density of 0.4 Kg/liter as the adsorbing material. Each zeolite bed had a length of 120 cm, diameter of 15.24 cm, and a weight of 26.3 kg. Compressor 20 has a capacity of 4.5 KW with 0.2 efficiency (hence 80% was used in the system as heat). The actual flow was 200 cfm. The laden exhaust gas was air with IPA (iso propyl alcohol) VOC and the inert gas nitrogen. The VOC load was 400 PPM. The flow on the regeneration side of the inert gas was 30 CFM The regeneration temperature was 150° C. First valve unit 14 and second vale unit 16 (shown in FIGS. 1A and 1C) each include two valves 2.5 inch valves controlling regeneration cycle (at inert gas inlet 14b and inert gas outlet 16b) and two 4 inch valves controlling the adsorption cycle (at laden exhaust gas inlet 14a and clean exhaust gas outlet 16a).

The amount of treated air in each cycle was 1312 m³ and the time of adsorbing all beds 12 adsorption was 3.86 hours. The regeneration cycle took 30 minutes and the time between generations was 142 minutes.

The total energy consumption in the entire adsorption-regeneration process was 0.57 KWh and 0.00286 KW/cfm. In comparison a commercial Rotary Concentrator Thermal Oxidizer (RCTO) system at similar conditions is expected to consume 323 KW and 0.0154 KW/cfm.

### Disclaimer

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A gas treatment system, comprising:
one or more volatile compound (VC) adsorbing units, each comprising:
a VC adsorbing bed comprising a porous VC adsorbing material; and
two or more valve units each connected at one end of the VC adsorbing bed;
at least one compressor configured to receive inert gas with adsorbed VC;
a heat exchanger configured to exchange heat between the compressed inert gas with adsorbed VC and a VC-free inert gas, wherein at least one of the valve units is configured to receive hot VC-free inert gas heated by the heat exchanger; and
a chiller configured to chill the compressed VC adsorbed inert gas to allow condensation of the VC from the VC adsorbed inert gas stream.

2. The gas treatment system of claim 1, wherein the two or more valve units comprises:
a first valve unit, interchangeably connecting the VC adsorbing bed to one of: laden exhaust gas inlet, and a VC adsorbed inert gas outlet, located at one end of the VC adsorbing bed; and
a second valve unit, interchangeably connecting the VC adsorbing bed to one of: a clean exhaust outlet, and to a VC-free inert gas inlet, located at another end of the VC adsorbing bed.

3. The gas treatment system of claim 1, further comprising a controller configured to control at least one of, any one of the valves, and the compressor.

4. The gas treatment system of claim 3, wherein the controller is configured to:
set a cleaning cycle by controlling at least one valve to provide laden exhaust gas to the VC adsorbing bed via the exhaust gas inlet and to control at least one other valve to extract cleaned exhaust gas via a cleaned exhaust gas outlet.

5. The gas treatment system of claim 3, wherein the controller is further configured to:
set a regeneration cycle by:
terminating the provision of laden exhaust gas to the VC adsorbing bed via the first valve;
controlling the provision of hot VC-free inert gas into the VC adsorbing bed via the second valve;
controlling the compressor to compress the VC adsorbed inert gas received from the first valve; and
controlling the chiller unit to recover VC from the VC adsorbed inert gas.

6. The gas treatment system of claim 5, wherein controlling the provision of hot VC-free inert gas comprises generating VC-free inert gas flow from an inert gas source based on a pressure difference between the inert gas source and the VC adsorbing bed.

7. The gas treatment system of claim 5, comprising, a first VC adsorbing unit and at least one more second VC adsorbing unit, and wherein the controller is configured to set the regeneration cycle for the first VC adsorbing unit, and to set the cleaning cycle for at least one more second VC adsorbing unit.

8. The gas treatment system of claim 7, wherein the regeneration cycle further comprises:
following the provision of hot VC-free inert gas into the VC adsorbing bed of the first VC adsorbing unit, controlling, the first valve, of the first VC adsorbing unit, to provide the VC adsorbed inert gas from the adsorbed bed, into the laden exhaust gas inlet of the second VC adsorbing unit.

9. The gas treatment system of claim 7, wherein providing the VC adsorbed inert gas from the first VC adsorbing unit is to an upstream of the adsorbed bed of the second VC adsorbing unit.

10. The gas treatment system of claim 2, further comprising a heater located before the VC-free inert gas inlet, and wherein the controller is configured to control the heater to heat the VC-free inert gas to a temperature of at least 150° C., if the temperature of the VC-free inert gas is below 150° C.

11. The gas treatment system of claim 1, wherein the heat exchanger is fluidically connected between the compressor and the chiller via VC adsorbed inert gas pipeline; and fluidically connected between an inert gas source, and at least one of the valve units, via VC-free inert gas pipeline.

12. The gas treatment system of claim 1, wherein the compressor is configured to compress the VC adsorbed inert gas to between 2 to 10 bar.

13. The gas treatment system of claim 12, wherein the temperature of the VC adsorbed inert gas at an exit from the compressor is at least 160° C.

14. The gas treatment system of claim 1, wherein the temperature of the VC-free inert gas at an exit from the heat exchanger is at least 140 °C.

15. The gas treatment system of claim 1, wherein the temperature of the VC adsorbed inert gas at an exit from the heat exchanger is at most 40 °C.

16. The gas treatment system of claim 1, wherein the Reynolds no. of the VC-free inert gas provided to the VC adsorbing unit is above 3000.

17. The gas treatment system of claim 1, wherein the inert gas is selected from nitrogen, helium, argon, carbon dioxide, and any combination thereof.

18. The gas treatment system of claim 1, wherein porous VC adsorbing material comprises at least one of: zeolite, activated carbon, metal-organic frameworks, special clay material, activated alumina, and hyper-crosslinked polymeric resin.

19. The gas treatment system of claim 1, further comprising at least one sensor configured to measure a value indicative of the ability of the porous VC adsorbing material to further adsorb VC.

20. The gas treatment system of claim 19, wherein the sensor is at least one of, a flowmeter, a delta pressure sensor, a scale, and exhaust motor load device.

21-27. (canceled)
